(19) United States
(12) Patent Application Publication
(10) Pub. No.: US 2016/0241067 A1
(43) Pub. Date: Aug. 18, 2016

(54) CELLPHONE DEVICE CHARGING CORD WITH INTEGRAL LIGHT SOURCE

(71) Applicant: Kevin Miracle, Commerce Township, MI (US)

(72) Inventor: Kevin Miracle, Commerce Township, MI (US)

(21) Appl. No.: 14/218,885

(22) Filed: Mar. 18, 2014

Related U.S. Application Data
(60) Provisional application No. 61/803,782, filed on Mar. 20, 2013.

(51) Int. Cl. H02J 7/00; H01R 13/717; G08B 5/36

(52) U.S. Cl. CPC H02J 7/0047; G08B 5/36; H02J 7/0042; H02J 7/0052; H01R 13/7175; H02J 2007/0062

(57) ABSTRACT

A handheld device power charging cord comprising a light-source and switch on the connector which supplies power to the handheld device. The switch is designed and positioned so that the switch is tactily evident when a user grabs the connector that plugs into the handheld device. The light-source is designed to provide a small amount of luminosity, so that the user can find the charging terminal in the handheld device in a darkened room. Alternatively, a handheld device with a light source built in close proximity to the charging port, which illuminates in low light conditions, or when the handheld device is oriented in a way indicating that the user is trying to connect the charging cord.

### FIELD OF INVENTION

This invention relates to the field of electricity: battery or capacitor charging or discharging. Specifically, this invention relates to the charging of handheld devices.

### BACKGROUND OF INVENTION

Often, engineers, lawyers, patent examiners, and others work late into the night. When they come home, they face a dilemma: how to plug in their handheld device charger-cord without turning on the bedroom light and waking their partner.

The ambient light from most modern handheld devices like Android® or i-Phone® mobile phones are either liquid crystal displays (“LCD”), organic light emitting diode (“OLED”), or light emitting diode (“LED”). With all of the currently available technologies, the screen view is 180° or less. Since the connector is at more than 180° from the screen, this means that the luminosity from the screen is of little help in lighting the charging connector of the handheld device, even in a dark room. Furthermore, no handheld devices currently exist with a lighted charging connector, or other facility to help connect the handheld device to the charging cord in low ambient light.

What consumers need is a facility that lights the connector of the handheld device in a darkened room. One way to do this would be with a charging cord that has a light at the tip of the connector that plugs into the handheld device. Ideally, the light should be an LED, so that very little light escapes to brighten the room, while the light, nonetheless, adequately illuminates the charging terminal of the handheld device. However, any type of light source in the tip of the connector plug would be an improvement over the current prior art. The light should only be on when the end of the charging cord is held, with the intention of inserting it into the handheld device charging terminal. The light should be of sufficient luminosity to illuminate the charging terminal of the handheld device in a dark room.

An alternative solution would be to mount an LED near the charging connector of a handheld device; or use an internal LED with a light pipe to illuminate the connector of the handheld device.

A survey of the current prior art shows several attempts to marry a light and a charging cord, but none of them solve the problem of connecting a charging cord to a handheld device in a dark room. For example, U.S. Pat. No. 6,639,382 by named inventor Fan, granted on Oct. 28, 2003, is entitled, “Mobile phone charger with automatic light” (“Fan 382”). Fan 382 discloses a mobile phone charger that has an automatic light built into a housing which also encompasses the wall plug. The lamp is activated in low light through the use of a photo-resistor. All the claims in this patent envision the light being attached to the wall plug casing. Clearly, this patent places the light at the “wrong” end. The end of the power charging cord for a handheld device that needs light in the dark is the end that plugs into the handheld device charging terminal.

Another attempt at marrying a charging cord to a light is U.S. Pat. No. 6,827,462 by named inventors Wangenheim, et. al., granted on Dec. 7, 2004, and entitled, “Charger with night light for portable electrical devices” (“Wangenheim 462”). Wangenheim 462 discloses an electronic device charger with a night light built into a housing connected to the charger. In one embodiment, the light is an electroluminescent cell in an integral housing. In another embodiment, the light is any lamp contained in a housing with one end connected to a traditional electric plug and the other end being an adaptor for an electronic device. Wangenheim 462 shows the invention as an integral housing, mid-wire on the cord between the wall plug and the adaptor. The specification does not identify plugging the charging cord into the cellphone in the dark as the problem that the invention attempts to overcome, and, again, the light is not in the appropriate place to illuminate the charging terminal of the handheld device.

Another variation on the theme of marrying a light to a charging cord for a handheld device is U.S. patent application Ser. No. 10/840,339, with publication number 2005/0093511 A1, filed on May 6, 2004 by named inventor Wu, and entitled, “Charger capable of providing illumination light” (“Wu 339”). Wu 339 discloses a charger which has a light built into a housing that also contains a connector to connect a portable electronic device such as a cellphone. The housing has a switch, printed circuit board, light, and connector for the portable electronic device. This application has multiple embodiments, including one in which a battery is in the housing to allow charging when no other power sources are available, and one in which the cellphone can be used as the power source to power the light. The light in this application is envisioned as being akin to a flashlight. The application does not address or suggest that the light is intended to help the user find the mobile phone charging terminal in the dark. Wu 339 discloses a relatively large housing on the handheld-device-end of the charging cord. The solution is clumsy, needlessly multi-faceted, and impractical for many consumers, due to the direction of the light and the size of the housing.

### SUMMARY OF THE INVENTION

The present invention improves upon conventional handheld device charging cords by adding an integral LED or other light source built into the end of the charging cord that inserts in the handheld device's charging terminal. The LED is partially enclosed by a sheath fabricated from plastic, thermoplastic elastomer, rubber, elastomer, or other flexible material. The light is offset from the end of the connector, so that the end of the connector can still fit in the charging terminal, even when the handheld device is contained in a cellphone case.

The LED or other light source is powered by the same power source that charges the handheld device, and is electrically in parallel with the charging port. The LED or other light source use the same power-pin and ground pin in the handheld device charging cord that delivers power to the handheld device's battery. The LED or other light source is in series with an appropriately sized and power-rated resistor, so that the LED or other light source is properly powered, without being over-powered. The LED is in series with a micro-button switch or other push-button-type switch. The micro-button switch or other push-button-type switch can either sit underneath the sheathing, on top of the LED or other light source; or it can protrude through a cut-out in the sheathing.

In this way, when the user grabs the charging cord by the end containing the charging connector for the handheld device, the user can easily depress the micro-switch or other push-button-type switch to turn-on the LED or other light source. The user can tactily find the switch in a darkened room, turn on the light, and illuminate the charging terminal of the handheld device, without disturbing anyone else sleeping in the same room.

The invention is broadly applicable to any type of mobile charging cord, including, but not limited to, USB, mini-USB, micro-USB, Motorola, HTC, i-Phone 4, and i-Phone 5. The invention can be integrated into a USB charger, a wall-charger, or even a car-charger.

An alternative embodiment of the invention is to insert the LED or other light source into the handheld device, adjacent to the charging port. Most handheld devices have gyroscopes and light sensors. Using these two devices, it would be easy to supply a LED or light source, which only illuminates in low light settings when the handheld device is inverted, putting the charging terminal on top.

### BRIEF DESCRIPTION OF THE DRAWINGS

FIG. 1 is a perspective drawing which shows the invention implemented with an i-Phone 4® USB charging cord, or equivalent.

FIG. 2 is a close-up perspective drawing of an i-Phone 4® charging connector or equivalent, with the invention integrated into the connector.

FIG. 3 is a perspective drawing which shows the invention implemented with a typical Motorola® USB charging cord, or equivalent.

FIG. 4 is a close-up perspective drawing of a typical Motorola® charging connector or equivalent, with the invention integrated into the connector.

FIG. 5 is a perspective drawing which shows the invention implemented with an i-Phone 5® USB charging cord or equivalent.

FIG. 6 is a close-up perspective drawing of an i-Phone 5® charging connector or equivalent, with the invention integrated into the connector.

FIG. 7 is an exploded drawing of a typical Motorola® USB handheld device charging connector or equivalent, with the invention integrated into the connector.

FIG. 8 is a perspective drawing which shows the invention implemented with a typical Motorola® wall-charging cord or equivalent.

FIG. 9 is a perspective drawing which shows a handheld device with a LED in close proximity to a charging port.

FIG. 10 is a perspective drawing which shows a handheld device with a light pipe about the periphery of the charging port.

### DETAILED DESCRIPTION OF THE PREFERRED EMBODIMENTS

The following descriptions are not meant to limit the invention, but rather to illustrate its general principles of operation. Examples are illustrated with the accompanying drawings. A variety of drawings are offered, showing the present invention incorporated into a variety of charging cords.

A traditional handheld charging cord has two ends. One goes into the power source, the other end, called a connector, goes into the handheld device to be charged. The end that goes into the power source can be a traditional wall plug or wall charger, a car charger, or a USB port.

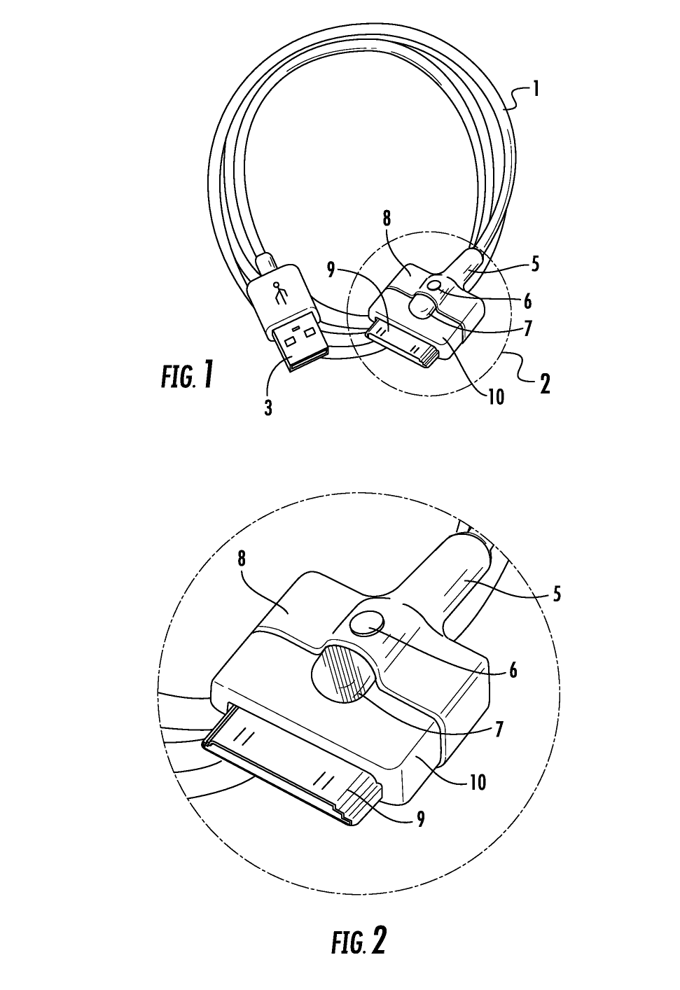

FIG. 1 shows a traditional i-Phone® 4 charging cord, comprised of a USB port 3, a wire encapsulated in a flexible insulating sheath 1, a connector for connecting to the charging port of the iPhone® 4 9. The connector for connecting to the charging port 9 is molded into a plastic block 10. The plastic block 10 is held in place by a sheath 8. An LED 7, mounted to the plastic block 10, is partially enclosed in the sheath 8. A micro-button switch 6 sits atop the LED 7 and protrudes through the sheath 8. To create structural stability, the sheath 8 has a piece 5 that extends down the wire 1 slightly. The LED 7 draws power from the USB ports power pin, is in parallel connection with the charging power delivered to the handheld device; and is in series with a resistor (not shown) that regulates current through the LED.

FIG. 2 shows a close-up of the end of the i-Phone® 4 charging cord that connects to the handheld device. All of the elements can be seen in greater detail: the connector for connecting to the charging port 9, the plastic block 10, the LED 7, the micro-button switch 6, the sheath 8 and the sheath extension 5.

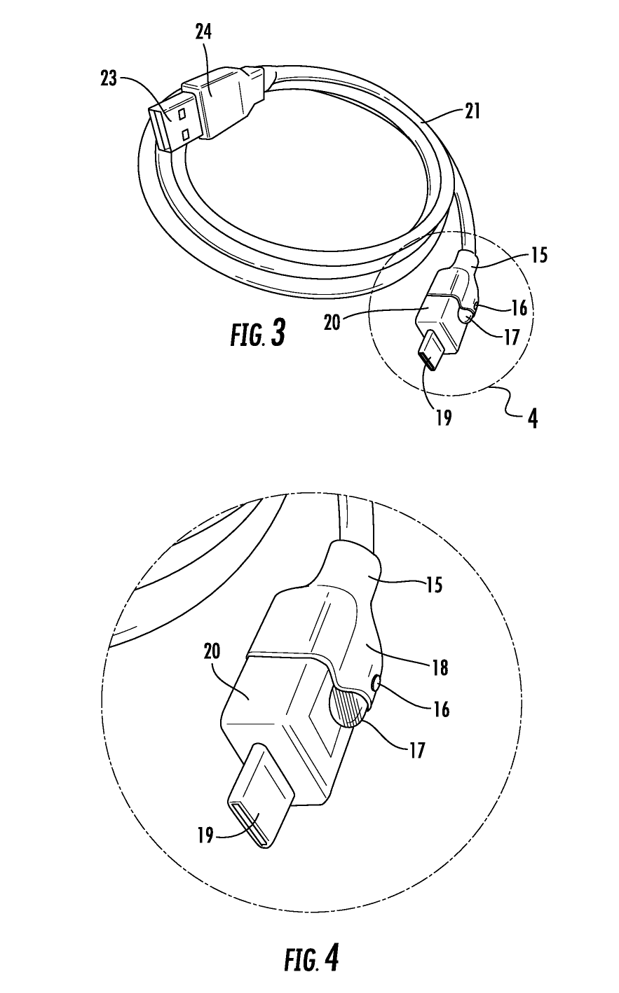

FIG. 3 shows a typical Motorola® USB charging cord, comprised of a USB port 23, a wire encapsulated in a flexible insulating sheath 21, a connector for connecting to the charging port of the Motorola® handheld device 19. The connector for connecting to the charging port 19 is molded into a plastic block 20. The plastic block 20 is covered by a sheath 18. An LED 17, mounted to the plastic block 20, is partially enclosed in the sheath 18. A micro-button switch 16 sits atop the LED 17 and protrudes through the sheath 18. To create structural stability, the sheath 18 has a piece 15 that extends down the wire 21 slightly. The LED 17 draws power from the USB ports 23 power pin, is in parallel connection with the charging power delivered to the handheld device; and is in series with a resistor (not shown) that regulates current through the LED 17.

FIG. 4 shows a close-up of the end of the Motorola® charging cord that connects to the handheld device. All of the elements can be seen in greater detail: the connector for connecting to the charging port 19, the plastic block 20, the LED 17, the micro-button switch 16, the sheath 18 and the sheath extension 15.

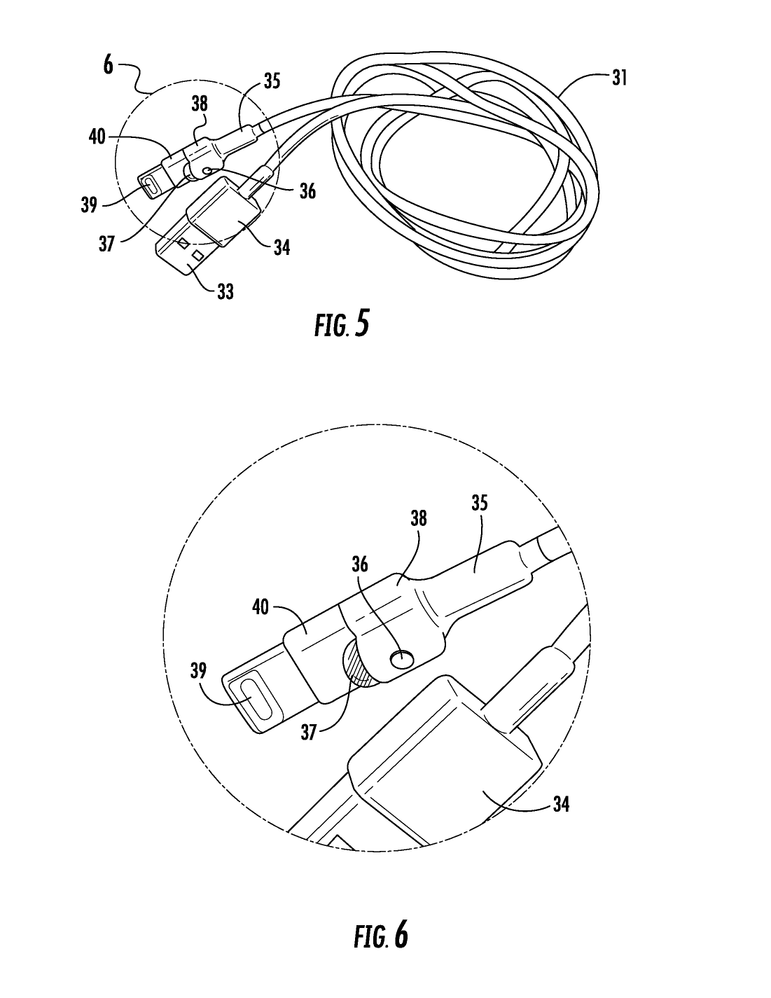

FIG. 5 shows an i-Phone® 5 charging cord, comprised of a USB port 33, 34, a wire encapsulated in a flexible insulating sheath 31, a connector for connecting to the charging port of the i-Phone® 5 39. The connector for connecting to the charging port 39 is molded into a plastic block 40. The plastic block 40 is covered by a sheath 38. To create structural stability, the sheath 38 has an extension piece 35 that extends down the wire 31 slightly.

FIG. 6 shows a close-up of the end of the i-Phone® 5 charging cord that connects to the handheld device. This end of the charging cord is comprised of the connector for connecting to the charging port 39, the plastic block 40, the LED 37, the micro-button switch 36, the sheath 38 and the sheath extension 35. Also visible in the close-up is the plastic block 34 of the USB connector.

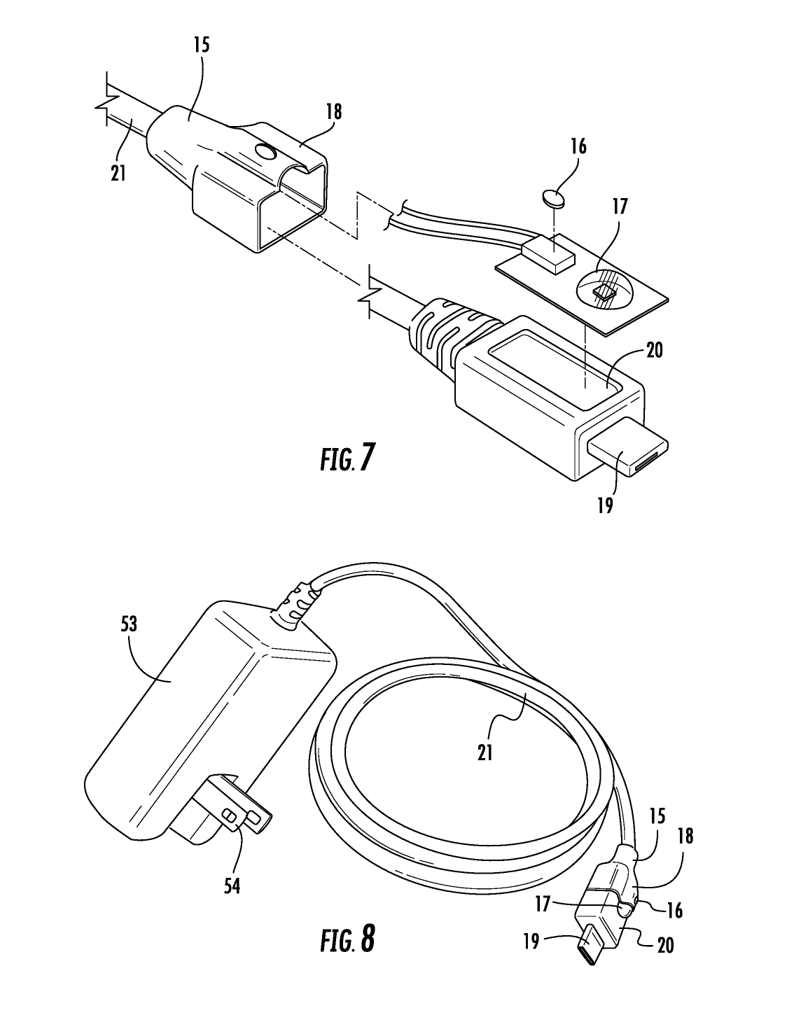

FIG. 7 shows an exploded view of the typical Motorola® connector, which is representative for generic handheld device connectors. This connector, which attaches to the charging port of the handheld device, is comprised of the connector for connecting to the charging port 19, the plastic block 20, the LED 17, the micro-button switch 16, the sheath 18 and the sheath extension 15. Also visible is the wire 21.

FIG. 8 shows a typical Motorola® charging cord with a wall plug, comprised of the connector for connecting to the charging port 19, the plastic block 20, the LED 17, the micro-button switch 16, the sheath 18 and the sheath extension 15. Also visible is the wire 21. FIG. 8 shows an embodiment with a wall plug 53. Although the invention is concerned with the design elements adjoining to the connector for the handheld device charging port 19, it can include either a wall plug 53, a USB plug (not shown in FIG. 8), or any other connector which can be attached to a power supply (not shown in FIG. 8).

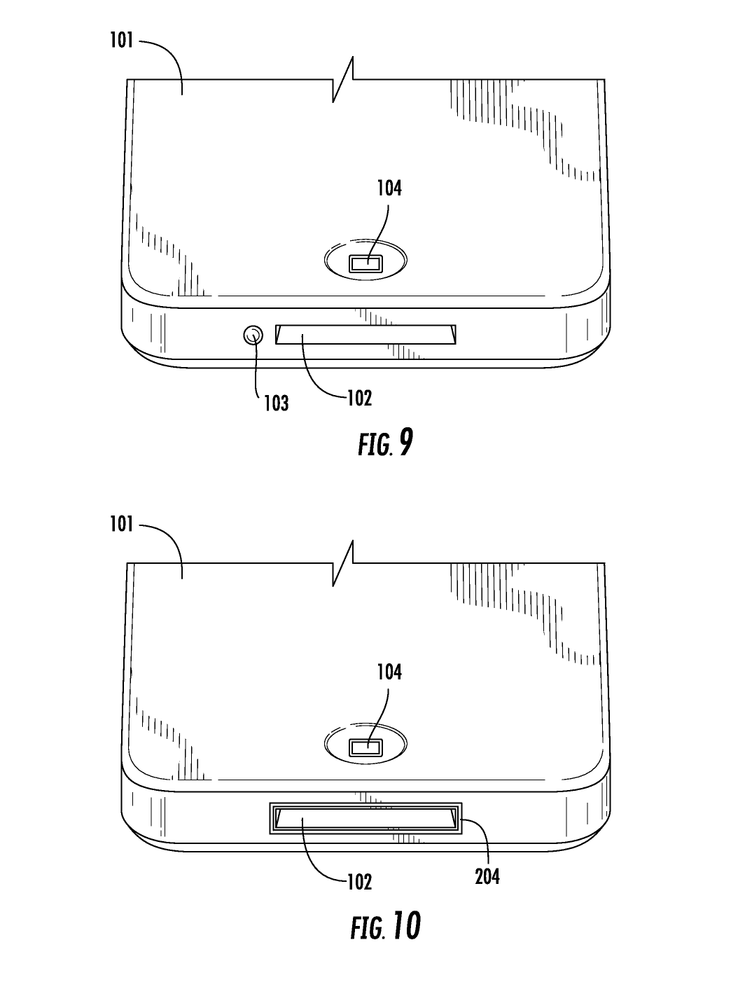

FIG. 9 shows a typical handheld device 101. From the perspective of FIG. 9, one can see cellphone has an all-purpose button 104 and a charging port 102. Adjacent to the charging port 102 is a LED. The LED 102 could be lit in a number of ways. First, the LED 102 could be lit when the user presses the all-purpose button 104, or any other functional button on the handheld device 101. Additionally, the LED 102 could be controlled by software, so that it lights when a built-in gyroscope senses that the charging port 102 is facing, more or less, in the upward direction. Additionally, if the handheld device 101 has a built-in camera with an auto-flash, the handheld device 101 would have a light sensor. The internal software of the handheld device 101 could be designed so that the light sensor has to indicate that the handheld device 101 is in a dark room in order for the LED to illuminate 103. Additionally, the internal software of the handheld device 101 could be designed so that the gyroscope and the light sensor both have to indicate that the handheld device 101 is being held so that the charging port 102 is facing up in a dark room, in order for the LED to illuminate 103. Lastly, the handheld device could require that optional software, often called, “apps,” be loaded in order to enable the LED 103. Such an app would allow the user to define the conditions required to light the LED 103, such as the handheld device 101 being inverted so that the charging port 102 is more or less facing up, a button 104 were to be depressed; a light sensor were to indicate a low light condition; or other user-defined conditions which would cause the LED 103 to light.

FIG. 10 shows the a light pipe 204 replacing the LED 103 from FIG. 9.

I claim:

1. A handheld device power charging cord comprised of a connector for connecting to the charging port of a handheld device; a plastic block to hold the connector for connecting to the charging port of the handheld device; a light source mounted in near proximity to the connector for the charging port of the handheld device; a switch for the light source, mounted on the top of the connector for the charging port of the handheld device, so that when a user picks up the charging cord by the connect, said user's thumb will land on the switch; a resistor or resistor network that is designed to deliver the appropriate amount of power to the light source when the switch is on; wires connecting the resistor or resistor network, light source, and switch to the power supply wire in the charging cord; and a sheath made of a flexible material to wrap and hold secure the plastic block, light source and switch.

2. The invention described in claim 1, wherein the light source is a light-emitting diode (“LED”).

3. The invention described in claim 1, wherein the switch for the light source is a micro-button switch.

4. The invention described in claim 1, wherein the power charging cord uses a USB Type “A” connector to supply power.

5. The invention described in claim 1, wherein the power charging cord uses a wall socket plug to supply power.

6. The invention described in claim 1, wherein the power charging cord uses an automotive cigarette lighter adapter to supply power.

7. A handheld device comprised of a minimum of a housing; a charging port; a light source situated to illuminate the charging port; a light sensor; a button or buttons; a gyro-scope or other means of electronically determining the physical orientation of the handheld device; a logic circuit, switch, and needed software to turn on the light source when the handheld devices is inverted in space so that the charging port is above the center of gravity of the device; and a switch connecting one or more buttons to the light source so that a user can turn on the light by pressing a button.

8. The invention described in claim 7, wherein the LED is illuminated when said light sensor within the handheld device senses that the room is dark.

9. The invention described in claim 7, wherein the LED is illuminated when the handheld device is inverted in space so that the charging port is above the center of gravity of the device; and a light sensor within the handheld device senses that the handheld device is in a dark room.

10. The invention described in claim 7, wherein the LED is illuminated when the software within the handheld device meets certain user-defined conditions that indicate that the charging light is needed.

11. The invention described in claim 10, wherein the software within the handheld device is purchased separately from the handheld device.
